(19) United States
(12) Patent Application Publication
(10) Pub. No.: US 2023/0029093 A1
(43) Pub. Date: Jan. 26, 2023

(54) Computing Framework for Vehicle Decision Making and Traffic Management

(71) Applicant: Nissan North America, Inc., Franklin, TN (US)

(72) Inventors: Liam Pedersen, San Francisco, CA (US); Najamuddin Mirza Baig, San Jose, CA (US); Maarten Sierhuis, San Francisco, CA (US)

(21) Appl. No.: 17/380,361

(22) Filed: Jul. 20, 2021

(51) Int. Cl. B60W 60/00; H04W 4/44; G08G 1/01; G08G 1/16; B60W 30/08

(52) U.S. Cl. CPC B60W 60/001; H04W 4/44; G08G 1/012; G08G 1/0145; G08G 1/164; B60W 30/08; B60W 2556/45; B60W 2420/42; B60W 2420/54

(57) ABSTRACT

A computing framework for addressing a variety of vehicle conditions includes receiving, from a first set of sensors by an edge compute node, first transportation network data associated with a transportation network region, receiving, from a second set of sensors by a cloud computing node, second transportation network data associated multiple transportation network regions, providing, by the edge compute node to one or more autonomous vehicles at the transportation network region, real-time transportation network region information based on at least the first transportation network data to facilitate control decisions by the one or more autonomous vehicles, and providing, by the cloud computing node to at least the one or more autonomous vehicles, non-real-time transportation network region information based on at least the second transportation network data to facilitate the control decisions by the at least one or more autonomous vehicles.

### TECHNICAL FIELD

This disclosure relates to connected vehicles and vehicle transportation networks, and more particularly to a computing framework for connected vehicle decision making and traffic management.

### BACKGROUND

Transportation network data from and related to vehicle transportation networks and users of and proximate to the vehicle transportation networks can be used to generate detailed, real-time, and semi-real-time knowledge of the location, state, and density of vehicle transportation network or road users. The knowledge is important for a variety of vehicle conditions including vehicle guidance, managing congestion, increasing safety, reducing environmental impact, reducing vehicle energy use, and reducing vehicle emissions. The transportation network data can be received or obtained from a variety of sources including fixed infrastructure such as traffic cameras and inductive-loop traffic sensors, self-reported location and state information from connected road users (as defined by the SAE J2735 standard), and connected vehicle mounted sensors. Processing, however, the collected transportation network data is complicated by the large volume, the geographically disparate sources, and the need for low latency (e.g. approximately 50 ms) for some data products or services (e.g. collision warning information).

### SUMMARY

Disclosed herein are aspects, features, elements, implementations, and embodiments of a computing framework for addressing a variety of vehicle conditions.

An aspect of the disclosed embodiments is a method for managing vehicle and traffic conditions. The method includes receiving, from a first set of sensors by an edge compute node, first transportation network data associated with a transportation network region, receiving, from a second set of sensors by a cloud computing node, second transportation network data associated multiple transportation network regions, providing, by the edge compute node to one or more autonomous vehicles at the transportation network region, real-time transportation network region information based on at least the first transportation network data to facilitate control decisions by the one or more autonomous vehicles, and providing, by the cloud computing node to at least the one or more autonomous vehicles, non-real-time transportation network region information based on at least the second transportation network data to facilitate the control decisions by the at least one or more autonomous vehicles.

Another aspect of the method includes receiving, from one or more edge compute nodes by the cloud computing node, respective first transportation network data.

Another aspect of the method includes receiving, from the cloud computing node by the edge compute node, the non-real-time transportation network region information, and determining, by the edge compute node, the real-time transportation network region information based on the non-real-time transportation network region information.

Another aspect of the method includes receiving, from one or more edge compute nodes by the cloud computing node, respective real-time transportation network region information, and determining, by the cloud computing node, the non-real-time transportation network region information based on the respective real-time transportation network region information.

In an aspect of the method, the real-time transportation network region information includes at least occluded collision hazard information for the transportation network region.

Another aspect of the method includes providing the real-time transportation network region information to facilitate collaborative control decisions as between the one or more autonomous vehicles.

Another aspect of the method includes providing, by the edge compute node to the one or more autonomous vehicles at transportation network region, real-time collaborative control decisions to facilitate autonomous vehicle collaboration at the transportation network region.

Another aspect of the method includes providing the non-real-time transportation network region information to facilitate congestion management decisions by the at least one or more autonomous vehicles.

Another aspect of the method includes providing the non-real-time transportation network region information to the at least one or more autonomous vehicles to facilitate collaborative congestion management decisions between the at least one or more autonomous vehicles.

Another aspect of the method includes providing, by the cloud computing node to the at least one or more autonomous vehicles, collaborative congestion management policy decisions to facilitate autonomous vehicle collaboration by the at least one or more autonomous vehicles.

Another aspect of the method includes providing the non-real-time transportation network region information to facilitate energy use determinations by the one or more autonomous vehicles.

In another aspect of the method, the second set of sensors includes at least the first set of sensors.

An aspect of the disclosed embodiments is a system which includes an edge compute device and a cloud computing platform. The edge compute device is configured to receive first transportation network data from a first set of sensors associated with a transportation network region and provide, to one or more connected vehicles at the transportation network region, real-time transportation network region information based on at least the first transportation network data to facilitate control decisions at the one or more connected vehicles. The cloud computing platform, which is connected to at least one or more edge compute devices, is configured to receive second transportation network data from a second set of sensors, and provide, to at least the one or more connected vehicles, non-real-time transportation network region information based on at least the second transportation network data to facilitate the control decisions at the at least one or more connected vehicles.

In another aspect of the system, the cloud computing platform is further configured to receive respective first transportation network data from the one or more edge compute nodes.

In another aspect of the system, the cloud computing platform is further configured to receive respective real-time transportation network region information from the one or more edge compute nodes, wherein the non-real-time transportation network region information is based on the respective real-time transportation network region information and the second transportation network data.

In another aspect of the system, the edge compute device is further configured to receive the non-real-time transportation network region information, wherein the real-time transportation network region information is based on the non-real-time transportation network region information.

In another aspect of the system, the real-time transportation network region information can facilitate one or more of notification of occluded collision hazard information and arbitrate collaborative control decisions as between the one or more autonomous vehicles.

In another aspect of the system, the non-real-time transportation network region information can facilitate congestion management decisions by the at least one or more autonomous vehicles and collaborative congestion management decisions between the at least one or more autonomous vehicles.

An aspect of the disclosed embodiments is an autonomous vehicle which includes a sensor system having one or more vehicle sensors, one or more processors that execute computer-readable instructions that cause the one or more processors to: receive, from an edge compute node, real-time transportation network region information based on at least first transportation network data associated with a transportation network region being traversed by the autonomous vehicle, receive, from a cloud computing node, non-real-time transportation network region information based on at least second transportation network data associated with multiple transportation network regions, the transportation network region being one of the multiple transportation network regions, determine a control action for the autonomous vehicle to perform based vehicle sensor data from the sensor system and at least one of the real-time transportation network region information and the non-real-time transportation network region information, and control the autonomous vehicle based on the control action.

In another aspect of the autonomous vehicle, the real-time transportation network region information can provide one or more of notification of occluded collision hazard information and collaborative control decision information as between other autonomous vehicles, and the non-real-time transportation network region information can provide congestion management decisions as between other autonomous vehicles and collaborative congestion management decisions with other autonomous vehicles.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which:

FIG. 1 is a diagram of an example of a vehicle in which the aspects, features, and elements disclosed herein may be implemented.

FIG. 2 is a diagram of an example of a portion of a vehicle transportation network and communication system in accordance with embodiments of this disclosure.

FIG. 3 is a diagram of an example of a vehicle transportation network and communication system in accordance with embodiments of this disclosure.

FIG. 4 is a diagram of an example of traffic occlusion in accordance with embodiments of this disclosure.

FIG. 5 is a diagram of an example of traffic occlusion in accordance with embodiments of this disclosure.

FIG. 6 is a diagram of an example of traffic occlusion in accordance with embodiments of this disclosure.

FIG. 7 is a diagram of an example of traffic occlusion in accordance with embodiments of this disclosure.

FIG. 8 is a diagram of an example of STSWM usage in a traffic occlusion in accordance with embodiments of this disclosure.

FIG. 9 is a diagram of an example of STSWM usage in accordance with embodiments of this disclosure.

FIG. 10 is a diagram of an example of STSWM usage in accordance with embodiments of this disclosure.

FIG. 11 is a diagram of an example of LTSWM usage in accordance with embodiments of this disclosure.

FIG. 12 is a diagram of an example of LTSWM usage in accordance with embodiments of this disclosure.

FIG. 13 is a flow diagram of an example of vehicle decision making and traffic management in accordance with embodiments of this disclosure.

### DETAILED DESCRIPTION

A system including a computing framework or computational architecture for providing vehicle decision making guidance and handling traffic management is described herein. Transportation network data for a transportation network can be received, obtained, or collected (collectively “collected”) from a variety of sources including, but not limited to, fixed infrastructure, self-reported location and state information from connected transportation network users, and connected vehicle mounted sensors. A transportation network may refer to a structure that permits vehicular movement (e.g., a road, street, highway, etc.). The sources for the transportation network data can be from different locations.

The system is configured to use a shared world model (SWM) for all road users and road conditions perceived from the transportation network data, where the shared world model is a common model of the location and state of the perceived road users and road conditions. The system is further configured to use a two-tier SWM to handle different types of vehicle conditions such as vehicle decision making guidance or congestion management. The SWM can include a short term shared world model (STSWM) and a long term shared world model (LTSWM). The STSWM can be used for vehicle conditions requiring immediacy in contrast to the LTSWM which can be used for vehicle conditions having longer temporal windows.

The STSWM can be directed to real-time location, speed, orientation, and other information or data of road users, updated sufficiently fast (e.g. low latency in the range of approximately 50 milliseconds (ms)) for other road users to plan steering and braking actions. In implementations, the STSWM can be used for modeling road conditions at locations with permanent sensors (e.g., infrastructure sensors) that guarantee coverage at all times. In implementations, the STSWM can be used to provide collision avoidance warnings. In implementations, the STSWM can be used to supplement a connected vehicle's or an autonomous vehicle's own perception in real-time.

The LTSWM can be directed to a statistical model of road conditions and other information that are durative in nature (i.e., remain valid for many minutes to hours, such as lane level traffic flow, pedestrian density, and similar transportation network characteristics or parameters). Stated in another way, the LTSWM is non-real-time in contrast to STSWM being real-time. In implementations, the LTSWM can be used for route planning, congestion management, infrastructure planning, and tasks that don't require real-time information.

The system can include an edge compute device or node to perform computations associated with the STSWM and a cloud computing platform to perform computations associated with the LTSWM. In implementations, the edge compute device can have a low latency link to an access point to enable usage of the computed STSWM by appropriate and applicable connected vehicles. In implementations, the edge compute device can compute a STSWM for regions or localized areas (such as an intersection) from geo-fenced data. In implementations, the cloud computing platform can be connected to multiple edge compute devices to obtain transportation network data and STSWMs, as appropriate, and directly to connected vehicles to obtain transportation network data, which can then be used to compute the LTSWM for multiple regions, for example.

In implementations, the two-tier SWM can provide technological improvements particular to controlling and routing autonomous vehicles, for example, those concerning the extension of computer network components to remotely monitor and tele-operate autonomous vehicles. The development of new ways to monitor autonomous vehicle network resources to, for example, identify hazards, identify obstacles, identify congestion, enable collaboration, and communicate instructions or information between the monitoring devices and the vehicles is fundamentally related to autonomous vehicle related computer networks.

In implementations, a technological improvement enables or provides enhanced safety in the use of autonomous vehicles by having the edge compute device share the STSWM amongst road users in an associated transportation network location, where the STSWM can include details regarding occluded collision hazards, including, but not limited to, approaching traffic and pedestrians (i.e., vehicle and traffic conditions).

In implementations, a technological improvement enables multi-agent collaboration as between road users in an associated transportation network location. The STSWM can provide the common scene understanding necessary for road users to collaborate at an intersection to increase throughput. In an example, a first vehicle can yield to a second vehicle as the second vehicle attempts to make or makes a left turn in an intersection.

In implementations, a technological improvement enables congestion management where the LTSWM is an analysis of lane level traffic conditions (e.g., vehicle density, speed, throughput, and other conditions) which enables the detection of lane blockages and identification of congestion management actions (e.g. lane closures, lane level speed limits, and other actions).

In implementations, a technological improvement enables curb use and parking availability where the LTSWM is an analysis of vehicle density, traffic entering a location, traffic exiting a location, and other similar indicators.

In implementations, a technological improvement enables prediction of environmental resource usage, energy usage, and combinations thereof where the LTSWM is an analysis of energy use parameters such as a coefficient of friction on a transportation network or a portion of a transportation network.

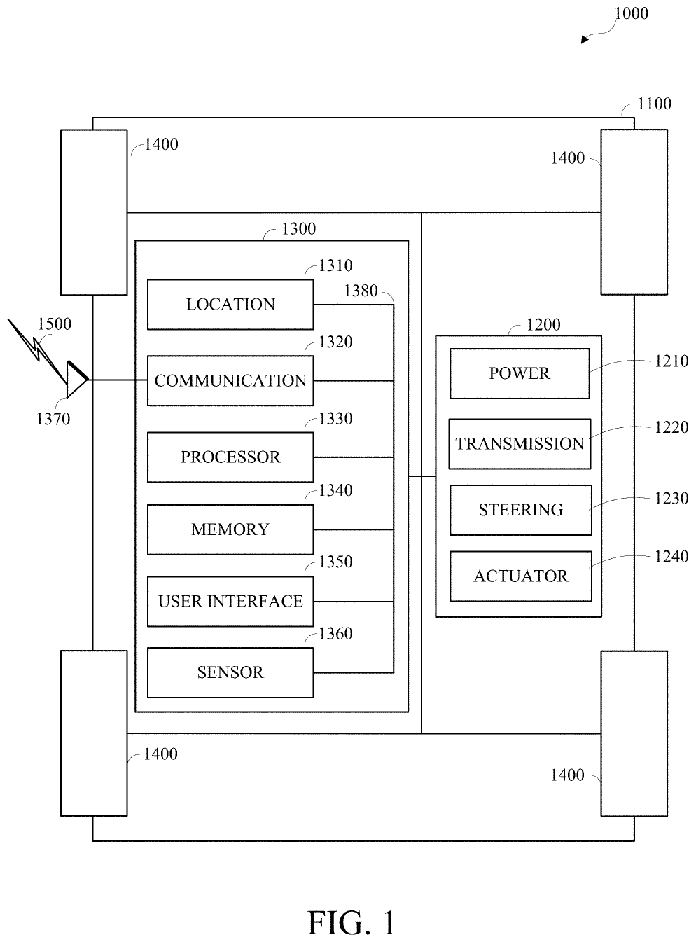

FIG. 1 is a diagram of an example of a vehicle in which the aspects, features, and elements disclosed herein may be implemented, may be implemented with, or combinations thereof. As shown, a vehicle 1000 includes a chassis 1100, a powertrain 1200, a controller 1300, and wheels 1400. Although the vehicle 1000 is shown as including four wheels 1400 for simplicity, any other propulsion device or devices, such as a propeller or tread, may be used. In FIG. 1, the lines interconnecting elements, such as the powertrain 1200, the controller 1300, and the wheels 1400, indicate that information, such as data or control signals, power, such as electrical power or torque, or both information and power, may be communicated between the respective elements. For example, the controller 1300 may receive power from the powertrain 1200 and may communicate with the powertrain 1200, the wheels 1400, or both, to control the vehicle 1000, which may include controlling a kinetic state of the vehicle, such as by accelerating or decelerating, controlling a directional state of the vehicle, such as by steering, or otherwise controlling the vehicle 1000.

As shown, the powertrain 1200 includes a power source 1210, a transmission 1220, a steering unit 1230, and an actuator 1240. Other elements or combinations of elements of a powertrain, such as a suspension, a drive shaft, axles, or an exhaust system may be included. Although shown separately, the wheels 1400 may be included in the powertrain 1200.

The power source 1210 may include an engine, a battery, or a combination thereof. The power source 1210 may be any device or combination of devices operative to provide energy, such as electrical energy, thermal energy, or kinetic energy. For example, the power source 1210 may include an engine, such as an internal combustion engine, an electric motor, or a combination of an internal combustion engine and an electric motor and may be operative to provide kinetic energy as a motive force to one or more of the wheels 1400. The power source 1210 may include a potential energy unit, such as one or more dry cell batteries, such as nickel-cadmium (NiCd), nickel-zinc (NiZn), nickel metal hydride (NiMH), and lithium-ion (Li-ion), solar cells, fuel cells, or any other device capable of providing energy.

The transmission 1220 may receive energy, such as kinetic energy, from the power source 1210, and may transmit the energy to the wheels 1400 to provide a motive force. The transmission 1220 may be controlled by the controller 1300 the actuator 1240 or both. The steering unit 1230 may be controlled by the controller 1300 the actuator 1240 or both and may control the wheels 1400 to steer the vehicle. The actuator 1240 may receive signals from the controller 1300 and may actuate or control the power source 1210, the transmission 1220, the steering unit 1230, or any combination thereof to operate the vehicle 1000.

As shown, the controller 1300 may include a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and the processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof may be integrated in one or more electronic units, circuits, or chips.

The processor 1330 may include any device or combination of devices capable of manipulating or processing a signal or other information now-existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

The memory 1340 may include any tangible non-transitory computer-usable or computer-readable medium, capable of, for example, containing, storing, communicating, or transporting machine readable instructions, or any information associated therewith, for use by or in connection with the processor 1330. The memory 1340 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 1370 may be a wireless antenna, as shown, a wired communication port, an optical communication port, or any other wired or wireless unit capable of interfacing with a wired or wireless electronic communication medium 1500. Although FIG. 1 shows the communication interface 1370 communicating via a single communication link, a communication interface may be configured to communicate via multiple communication links. Although FIG. 1 shows a single communication interface 1370, a vehicle may include any number of communication interfaces.

The communication unit 1320 may be configured to transmit or receive signals via a wired or wireless electronic communication medium 1500, such as via the communication interface 1370. Although not explicitly shown in FIG. 1, the communication unit 1320 may be configured to transmit, receive, or both via any wired or wireless communication medium, such as radio frequency (RF), ultraviolet (UV), visible light, fiber optic, wireline, or a combination thereof. Although FIG. 1 shows a single communication unit 1320 and a single communication interface 1370, any number of communication units and any number of communication interfaces may be used. In some embodiments, the communication unit 1320 may include a dedicated short-range communications (DSRC) unit, an on-board unit (OBU), or a combination thereof.

The location unit 1310 may determine geolocation information, such as longitude, latitude, elevation, direction of travel, or speed, of the vehicle 1000. For example, the location unit may include a global positioning system (GPS) unit, such as a Wide Area Augmentation System (WAAS) enabled National Marine-Electronics Association (NMEA) unit, a radio triangulation unit, or a combination thereof. The location unit 1310 can be used to obtain information that represents, for example, a current heading of the vehicle 1000, a current position of the vehicle 1000 in two or three dimensions, a current angular orientation of the vehicle 1000, or a combination thereof.

The user interface 1350 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 1350 may be operatively coupled with the processor 1330, as shown, or with any other element of the controller 1300. Although shown as a single unit, the user interface 1350 may include one or more physical units. For example, the user interface 1350 may include an audio interface for performing audio communication with a person and a touch display for performing visual and touch-based communication with the person. The user interface 1350 may include multiple displays, such as multiple physically separate units, multiple defined portions within a single physical unit, or a combination thereof.

The sensor 1360 may include one or more sensors, such as an array of sensors, which may be operable to provide information that may be used to control the vehicle. The sensors 1360 may provide information regarding current operating characteristics of the vehicle 1000. The sensor 1360 can include, for example, a speed sensor, acceleration sensors, a steering angle sensor, traction-related sensors, braking-related sensors, steering wheel position sensors, eye tracking sensors, seating position sensors, or any sensor, or combination of sensors, operable to report information regarding some aspect of the current dynamic situation of the vehicle 1000.

The sensor 1360 may include one or more sensors operable to obtain information regarding the physical environment surrounding the vehicle 1000. For example, one or more sensors may detect road geometry and features, such as lane lines, and obstacles, such as fixed obstacles, vehicles, and pedestrians. The sensor 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 1360 and the location unit 1310 may be a combined unit.

Although not shown separately, the vehicle 1000 may include a trajectory controller. For example, the controller 1300 may include the trajectory controller. The trajectory controller may be operable to obtain information describing a current state of the vehicle 1000 and a route planned for the vehicle 1000, and, based on this information, to determine and optimize a trajectory for the vehicle 1000. In some embodiments, the trajectory controller may output signals operable to control the vehicle 1000 such that the vehicle 1000 follows the trajectory that is determined by the trajectory controller. For example, the output of the trajectory controller can be an optimized trajectory that may be supplied to the powertrain 1200, the wheels 1400, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 1400 may be a steered wheel, which may be pivoted to a steering angle under control of the steering unit 1230, a propelled wheel, which may be torqued to propel the vehicle 1000 under control of the transmission 1220, or a steered and propelled wheel that may steer and propel the vehicle 1000.

Although not shown in FIG. 1, a vehicle may include units, or elements, not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 1000 may be an autonomous vehicle controlled autonomously, without direct human intervention, to traverse a portion of a vehicle transportation network. Although not shown separately in FIG. 1, an autonomous vehicle may include an autonomous vehicle control unit, which may perform autonomous vehicle routing, navigation, and control. The autonomous vehicle control unit may be integrated with another unit of the vehicle. For example, the controller 1300 may include the autonomous vehicle control unit.

The autonomous vehicle control unit may control or operate the vehicle 1000 to traverse a portion of the vehicle transportation network in accordance with current vehicle operation parameters. The autonomous vehicle control unit may control or operate the vehicle 1000 to perform a defined operation or maneuver, such as parking the vehicle. The autonomous vehicle control unit may generate a route of travel from an origin, such as a current location of the vehicle 1000, to a destination based on vehicle information, environment information, vehicle transportation network data representing the vehicle transportation network, or a combination thereof, and may control or operate the vehicle 1000 to traverse the vehicle transportation network in accordance with the route. For example, the autonomous vehicle control unit may output the route of travel to the trajectory controller, and the trajectory controller may operate the vehicle 1000 to travel from the origin to the destination using the generated route.

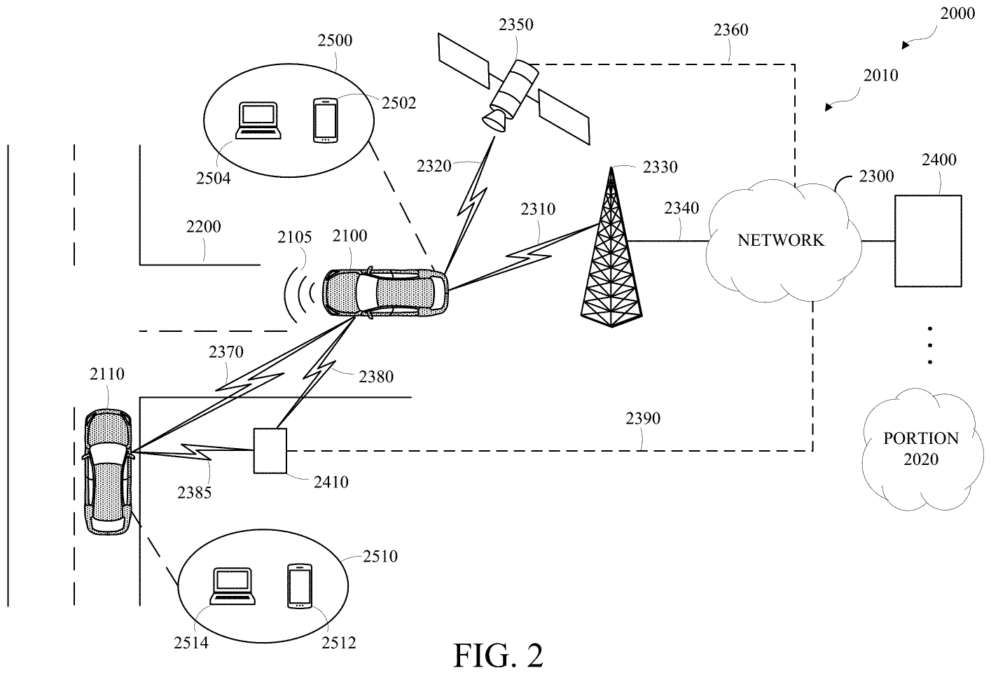

FIG. 2 is a diagram of an example of portions of a vehicle transportation and communication system in which the aspects, features, and elements disclosed herein may be implemented. The vehicle transportation and communication system 2000 may include one or more portions 2010 and 2020 where some components or elements may overlap. A portion 2010 of the vehicle transportation and communication system 2000 may include one or more vehicles 2100/2110, such as the vehicle 1000 shown in FIG. 1, which may travel via one or more portions, such as the portions 2010 and 2020, of one or more vehicle transportation networks 2200 and may communicate via one or more electronic communication networks 2300 (which can be referred to as a “connected vehicle” as appropriate and applicable). For example, the one or more vehicles 2100/2110 can be a vehicle with no automation, a vehicle with driver assistance, a vehicle with partial automation, a vehicle with conditional automation, a vehicle with high automation, a vehicle with full automation, or combinations thereof. For example, the one or more vehicles 2100/2110 can be a level 0 vehicle, a level 1 vehicle, a level 2 vehicle, a level 3 vehicle, a level 4 vehicle, a level 5 vehicle, or combinations thereof as defined by the Society of Automotive Engineers (SAE) International.

Although not explicitly shown in FIG. 2, a vehicle may traverse an area that is not expressly or completely included in a vehicle transportation network, such as an off-road area.

The electronic communication network 2300 may be, for example, a multiple access system and may provide for communication, such as voice communication, data communication, video communication, messaging communication, or a combination thereof, between the vehicle 2100/2110 and one or more compute devices, such as a cloud computing platform or device 2400 and an edge computing device 2410. The edge computing device 2410 may be associated with a defined region of the vehicle transportation network, such as a lane, a road segment, a contiguous group of road segments, a road, or an intersection, or a defined geographic region, such as a block, a neighborhood, a district, a county, a municipality, a state, a country, or another defined geographic region. In FIG. 2, the region is the portion 2010. The cloud computing platform or device 2400 can be associated with multiple regions and connected to multiple edge computing devices. In FIG. 2, the multiple regions are the portions 2010 and 2020.

In an example, a vehicle 2100/2110 may receive LTSWM or non-real-time information, such as information representing the vehicle transportation network 2200, from the cloud computing platform or device 2400 via the network 2300. For example, the LTSWM or non-real-time information can be statistical based analysis of vehicle transportation network data collected with respect to the portions 2010 and 2020. A vehicle 2100/2110 may receive STSWM or real-time information, such as information representing the vehicle transportation network 2200, from a communication device 2410 via direct wireless communication. For example, the STSWM or real-time information can be real time location, speed, and orientation of road users, such as the vehicles 2100 and 2110, based on vehicle transportation network data collected with respect to the portion 2010, which is updated sufficiently fast for the vehicles 2100 and 2110 to plan steering and braking actions.

The vehicle transportation network data may be expressed as a hierarchy of elements, such as markup language elements, which may be stored in a database or file. For simplicity, the figures herein depict vehicle transportation network data representing portions of a vehicle transportation network as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

In some embodiments, a vehicle 2100/2110 may communicate via a wired communication link (not shown), a wireless communication link 2310/2320/2370/2380/2385, or a combination of any number of wired or wireless communication links. For example, as shown, a vehicle 2100/2110 may communicate via a terrestrial wireless communication link 2310, via a non-terrestrial wireless communication link 2320, or via a combination thereof. The terrestrial wireless communication link 2310 may include an Ethernet link, a serial link, a Bluetooth link, an infrared (IR) link, an ultraviolet (UV) link, or any link capable of providing for electronic communication.

A vehicle 2100/2110 may communicate with another vehicle 2100/2110. For example, a host, or subject, vehicle (HV) 2100 may receive one or more automated inter-vehicle messages, such as a basic safety message (BSM), from a remote, or target, vehicle (RV) 2110, via a direct communication link 2370, or via the network 2300. For example, the remote vehicle 2110 may broadcast the message to host vehicles within a defined broadcast range, such as 300 meters. In some embodiments, the host vehicle 2100 may receive a message via a third party, such as a signal repeater (not shown) or another remote vehicle (not shown). A vehicle 2100/2110 may transmit one or more automated inter-vehicle messages periodically, based on, for example, a defined interval, such as 100 milliseconds. The direct communication link 2370 may be, for example, a wireless communication link.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state. The vehicle transportation network data may include the automated inter-vehicle messages.

The vehicle 2100 may communicate with the communications network 2300 via an access point 2330. The access point 2330, which may include a computing device, may be configured to communicate with a vehicle 2100, with a communication network 2300, with one or more compute devices 2400/2410, or with a combination thereof via wired or wireless communication links 2310/2340. For example, the access point 2330 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit in FIG. 2, an access point may include any number of interconnected elements.

The vehicle 2100 may communicate with the communications network 2300 via a satellite 2350, or other non-terrestrial communication device. The satellite 2350, which may include a computing device, may be configured to communicate with a vehicle 2100, with a communication network 2300, with one or more compute devices 2400/2410, or with a combination thereof via one or more communication links 2320/2360. Although shown as a single unit in FIG. 2, a satellite may include any number of interconnected elements.

An electronic communication network 2300 may be any type of network configured to provide for voice, data, or any other type of electronic communication. For example, the electronic communication network 2300 may include a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit in FIG. 2, an electronic communication network may include any number of interconnected elements. The compute devices 2400/2410 may communicate, such as via a communication link 2390.

The vehicle 2100 may identify a portion or condition of the vehicle transportation network 2200. For example, the vehicle 2100 may include one or more on-vehicle sensors 2105, such as sensor 1360 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 2200. The sensor data may include lane line data, remote vehicle location data, or both. The vehicle transportation network data may include the sensor data.

The vehicle 2100 may traverse a portion or portions of one or more vehicle transportation networks 2200 using information communicated via the network 2300, such as information representing the vehicle transportation network 2200, information identified by one or more on-vehicle sensors 2105, or a combination thereof.

Although, for simplicity, FIG. 2 shows two vehicles 2100, 2110, one vehicle transportation network 2200, one electronic communication network 2300, and two compute devices 2400/2410, any number of vehicles, networks, or computing devices may be used. The vehicle transportation and communication system 2000 may include devices, units, or elements not shown in FIG. 2. Although the vehicle 2100 is shown as a single unit, a vehicle may include any number of interconnected elements.

Although the vehicle 2100 is shown communicating with the compute device 2400 via the network 2300, the vehicle 2100 may communicate with the compute device 2400 via any number of direct or indirect communication links. For example, the vehicle 2100 may communicate with the compute device 2400/2410 via a direct communication link, such as a Bluetooth communication link.

In some embodiments, a vehicle 2100/2210 may be associated with an entity 2500/2510, such as a driver, operator, or owner of the vehicle. In some embodiments, an entity 2500/2510 associated with a vehicle 2100/2110 may be associated with one or more personal electronic devices 2502/2504/2512/2514, such as a smartphone 2502/2512 or a computer 2504/2514. In some embodiments, a personal electronic device 2502/2504/2512/2514 may communicate with a corresponding vehicle 2100/2110 via a direct or indirect communication link. Although one entity 2500/2510 is shown as associated with one vehicle 2100/2110 in FIG. 2, any number of vehicles may be associated with an entity and any number of entities may be associated with a vehicle.

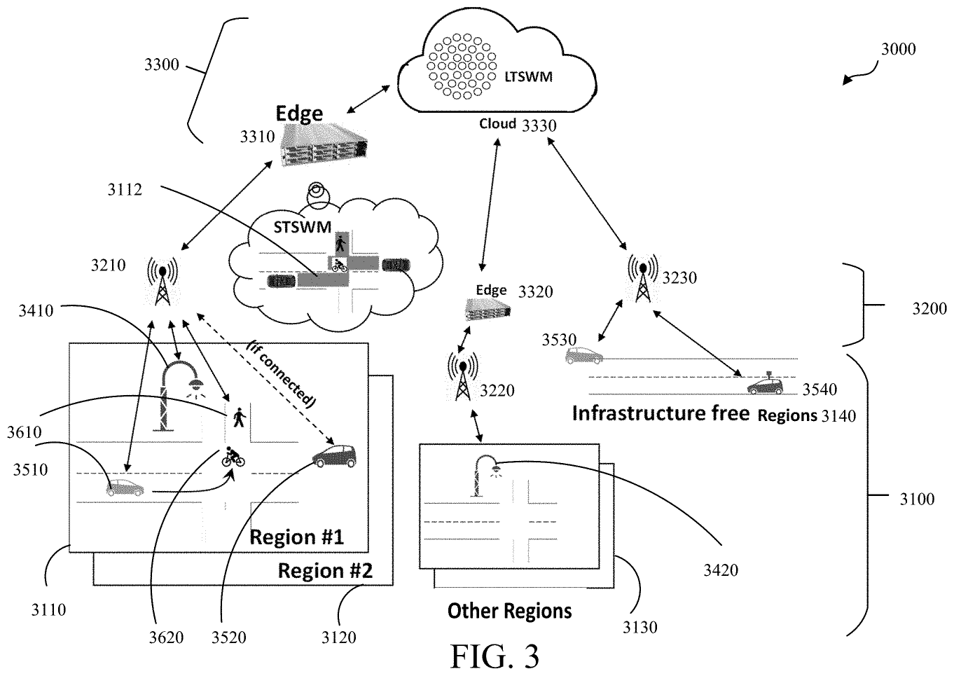

FIG. 3 is a diagram of an example of a vehicle transportation and communication system with a two-tier SWM computing architecture in which the aspects, features, and elements disclosed herein may be implemented. The elements and components shown in FIG. 2 can be included as appropriate and applicable and are not shown for ease of description and illustration of related elements and components. The vehicle transportation and communication system 3000 may include a vehicle transportation network 3100, a communication system 3200, and a compute system 3300.

The vehicle transportation network 3100 may include multiple regions such as, but not limited to, region 1 3110, region 2 3120, other regions 3130, and infrastructure free region 3140. For example, a region maybe a lane, a road segment, a contiguous group of road segments, a road, or an intersection, or a defined geographic region, such as a block, a neighborhood, a district, a county, a municipality, a state, a country, or another defined geographic region. Some regions may include vehicle transportation network infrastructure which may sense or capture vehicle transportation network data. For example, the region 1 3110 can include a roadside light 3410 and other regions 3130 can include a roadside light 3420. Some regions may include one or more vehicles which may travel via the regions of the vehicle transportation networks 3100 and may communicate via the communication system 3200 or other communication links as shown in FIG. 1. For example, the vehicles may be vehicles 3510 and 3520 in the region 1 3110, and vehicles 3530 and 3540 in the infrastructure free region 3140. Each of these vehicles can be a vehicle type as described in FIG. 1. Each of these vehicles can be a connected vehicle as appropriate and applicable. Some regions may include one or more non-vehicle or vulnerable users which may the travel via the regions of the vehicle transportation networks 3100. For example, the non-vehicle user may be non-vehicle users 3610 and 3620 in the region 1 3110. In an example, the non-vehicle users 3610 and 3620 may provide vehicle transportation network data via devices located with the non-vehicle user, such as a mobile phone or similar devices.

The communication system 3200 may include access points such as access point 3210, access point 3220, and access point 3230. The communication system 3200 may include the communication links as described in FIG. 1. The communication system 3200 may enable communications between users of the vehicle transportation network 3100 and infrastructure in the vehicle transportation network 3100 such as the roadside light 3410, the roadside light 3420, the vehicles 3510, 3520, 3530, and 3540, the non-vehicle users 3610 and 3620, and the compute system 3300. For example, vehicle transportation network data from the users and infrastructure (vehicle transportation network data providers or sensors) may be transmitted to the compute system 3300 and transportation network information based on the vehicle transportation network data may be provided to the users by the compute system 3300 as described herein. The transportation network information can include, for example, real-time transportation network information and non-real-time transportation network information.

The compute system 3300 may include one or more edge compute devices such as edge compute device 3310, edge compute device 3320, and a cloud compute platform 3330. The edge computing device 3310 may be associated with a defined region of the vehicle transportation network. The cloud computing platform or device 3330 can be associated with multiple regions and connected to multiple edge computing devices. Although edge compute devices are described herein, other decentralized compute devices may be used. Although a cloud compute platform is described herein, other centralized compute platforms may be used.

The edge compute devices such as the edge compute device 3310 and the edge compute device 3320 can have low latency communication links with at least one of the access points so that real-time transportation network information can be provided to an associated or applicable region. That is, each access point may be associated with one or more regions to enable usage of the real-time transportation network information by appropriate users in the region. The edge compute devices can provide STSWM or real-time information, such as information representing the vehicle transportation network 3100, to road users in an associated region. For example, the STSWM or real-time information can be real time location, speed, and orientation of road users, such as the vehicles 3510 and 3520, based on vehicle transportation network data collected with respect to the region, which is updated sufficiently fast for the vehicles 3510 and 3520 to plan steering and braking actions. For example, different levels of information can be provided based on type of user ranging from alerts, vehicle control actions, vehicle control data. The computing platform or device 3330 can provide LTSWM or non-real-time information, such as information representing the vehicle transportation network 3100. For example, the LTSWM or non-real-time information can be statistical based analysis of vehicle transportation network data collected with respect to one or more regions such the region 1 3110, the region 2 3120, the other regions 3130, and the infrastructure free region 3140.

The edge compute devices such as the edge compute device 3310 and the edge compute device 3320 and the computing platform or device 3330 can include a world modeling module, which can track and maintain state information for at least some detected objects such as vehicles, non-vehicle or vulnerable users, and combinations thereof based on vehicle transportation network data from each of the vehicle transportation network data sources. The world modeling module can predict one or more potential hypotheses (i.e., trajectories, paths, or the like) for the tracked objects. The world modeling module can be implemented as described in International Publication Number WO 2019/231455 entitled “Trajectory Planning”, filed on May 21, 2018, which is incorporated herein by reference in its entirety (“the '455 Publication”). The world modeling module receives vehicle transportation network data from each of the vehicle transportation network data sources. The world modeling module determines the objects from the received vehicle transportation network data. The world modeling module can maintain a state of the object including one or more of a velocity, a pose, a geometry (such as width, height, and depth), a classification (e.g., bicycle, large truck, pedestrian, road sign, etc.), and a location. As such, the state of an object includes discrete state information (e.g., classification) and continuous state information (e.g., pose and velocity). The edge compute devices such as the edge compute device 3310 and the edge compute device 3320 and the computing platform or device 3330 can use seamless autonomous mobility (SAM) data as provided by the vehicle transportation network data sources to enable vehicles to operate safely and smoothly on the road as described in the '455 Publication. The edge compute devices such as the edge compute device 3310 and the edge compute device 3320 and the computing platform or device 3330 can implement vehicle guidance methodologies as described in U.S. patent application Ser. No. 17/243,919, entitled “Vehicle Guidance with Systemic Optimization”, and filed Apr. 29, 2021, which is incorporated herein by reference in its entirety. The method can include, but is not limited to, obtaining vehicle operational data for a region of a vehicle transportation network, wherein the vehicle operational data includes current operational data for a plurality of vehicles operating in the region, operating a systemic-utility vehicle guidance model for the region, obtaining systemic-utility vehicle guidance data for the region from the systemic-utility vehicle guidance model in response to the vehicle operational data, and outputting the systemic-utility vehicle guidance data. The techniques and methods can be used to generate the STSWM or real-time information, the LTSWM or non-real-time information, or combinations thereof as appropriate and applicable, from multiple vehicle transportation network data sources or sensors.

For example, in FIG. 3., the edge compute device 3310 can generate from the vehicle transportation network data obtained from the at least the vehicles 3510 and 3520 and provide real-time transportation network region information 3112 (represented by at least the shaded areas) to at least the vehicles 3510 and 3520. The real-time transportation network region information 3112 may include information as described herein for each of the vehicles 3510 and 3520 and the non-vehicle users 3610 and 3620 as perceived by the vehicles 3510 and 3520, the non-vehicle users 3610 and 3620, or combinations thereof, for example. The real-time transportation network region information 3112 may be provided to the non-vehicle users 3610 and 3620 in the event the non-vehicle users 3610 and 3620 have devices for receiving the same.

The edge compute devices such as the edge compute device 3310 and the edge compute device 3320 and the computing platform or device 2400 may provide the STSWM or real-time information and the LTSWM or non-real-time information to facilitate control decisions by the one or more vehicles 3510 and 3520, which may be based one or more of the STSWM or real-time information, the LTSWM or non-real-time information, and combinations thereof. This can, for example, be used to provide control actions, alerts, or combinations thereof to vehicles of other vehicles and non-vehicles in the region.

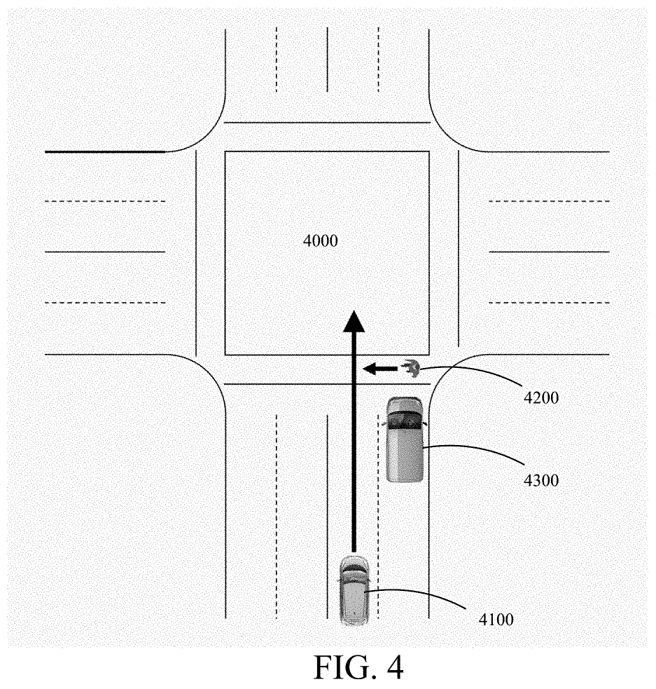

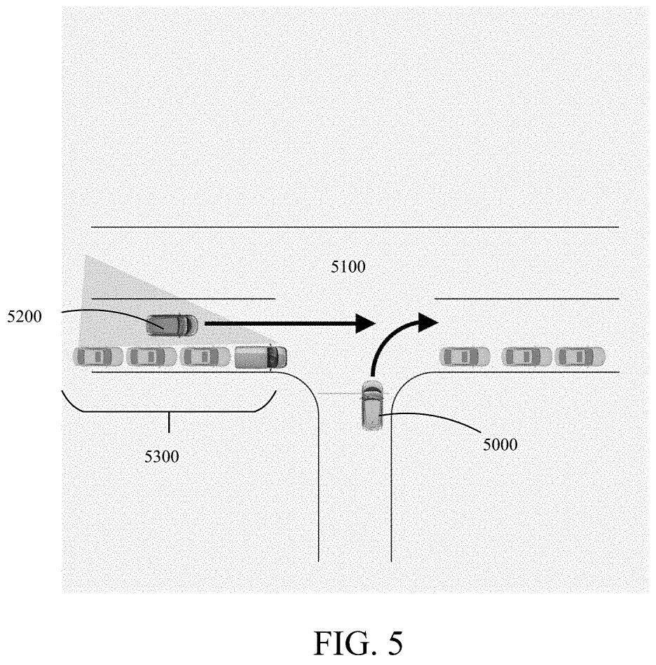

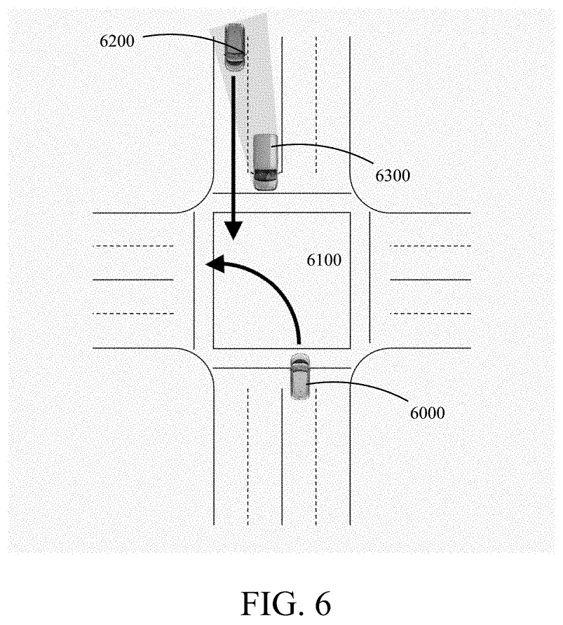

The edge compute devices such as the edge compute device 3310 and the edge compute device 3320 and the computing platform or device 2400 may provide the STSWM or real-time information and the LTSWM or non-real-time information to facilitate other actions. For example, the STSWM or real-time information can “reveal” unseen hazards from a perspective of the vehicle by using transportation network data from other vehicle transportation network sources or sensors. For example, objects hidden by parked vehicles, objects nearly invisible due to lighting conditions, potential incoming vehicles into a predicted path, and other non-controllable or invisible objects. This can be seen in FIGS. 4-8, which show various traffic occlusion situations where the STSWM or real-time information can provide visibility by using or combining information from data sources other than the instant vehicle. In FIG. 4, a vehicle 4100 entering an intersection 4000 is unable to perceive a pedestrian 4200 due to a vehicle 4300. In FIG. 5, vehicle 5100 entering an intersection 5000 is unable to perceive a vehicle 5200 due to vehicles 5300. In FIG. 6, vehicle 6100 making a left turn in an intersection 6000 is unable to perceive a vehicle 6200 due to vehicle 6300.

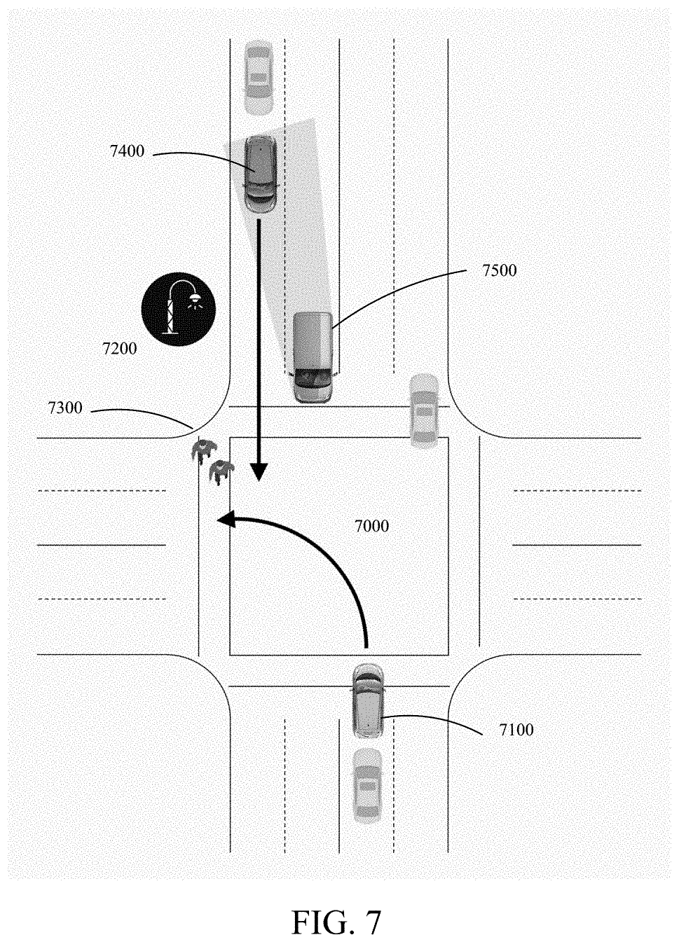

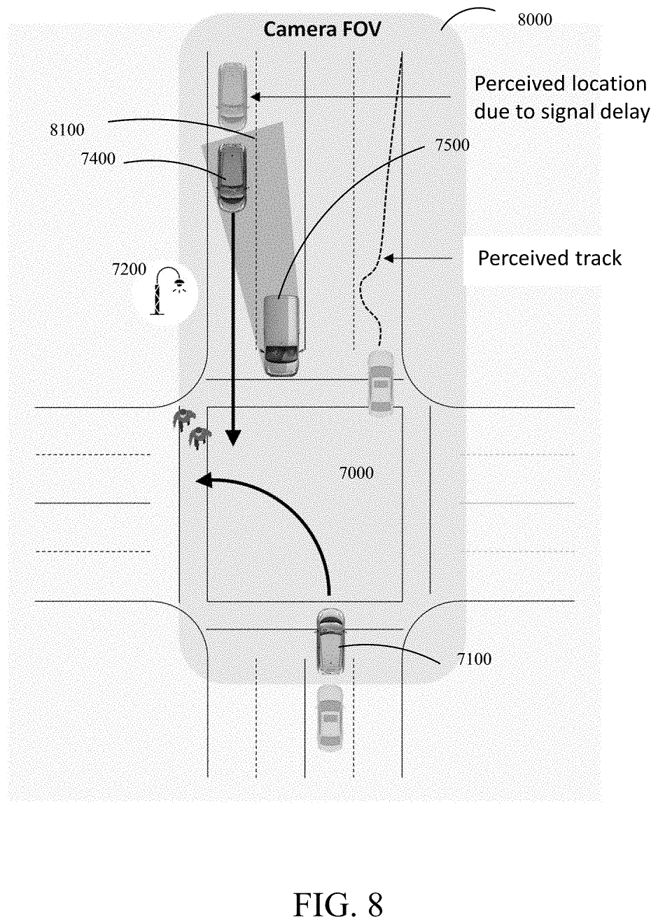

FIG. 7 shows an intersection 7000 where a vehicle 7100 is attempting to make a left turn. The intersection 7000 includes an infrastructure sensor-roadside light 7200, such as an infrastructure camera. As shown, the vehicle 7100 can perceive pedestrians 7300 but cannot perceive vehicle 7400 due to vehicle 7500. In this instance an edge compute device can obtain transportation network data from the infrastructure sensor-roadside light 7200, the vehicle 7400, the vehicle 7500, and other sources in the intersection 7000 to generate STSWM or real-time information which can be used by the vehicle 7100 to control or direct vehicle actions accordingly. This is shown for example in FIG. 8, where the infrastructure sensor-roadside light 7200 has a field of view 8000, the vehicle 7400 has a sensor field of view 8100, the vehicle 7400 has GPS data, and sensor data from each of the vehicles in or near the intersection 7000, all of which is used (e.g., fused) by the edge compute device to detect the objects in the intersection 7000, track predicted movement, and generate STSWM or real-time information for the vehicle 7100.

The edge compute devices such as the edge compute device 3310 and the edge compute device 3320 may provide the STSWM or real-time information to facilitate merging assistance by using transportation network data from other vehicle transportation network sources or sensors and providing alerts to a merging vehicle as to when to merge.

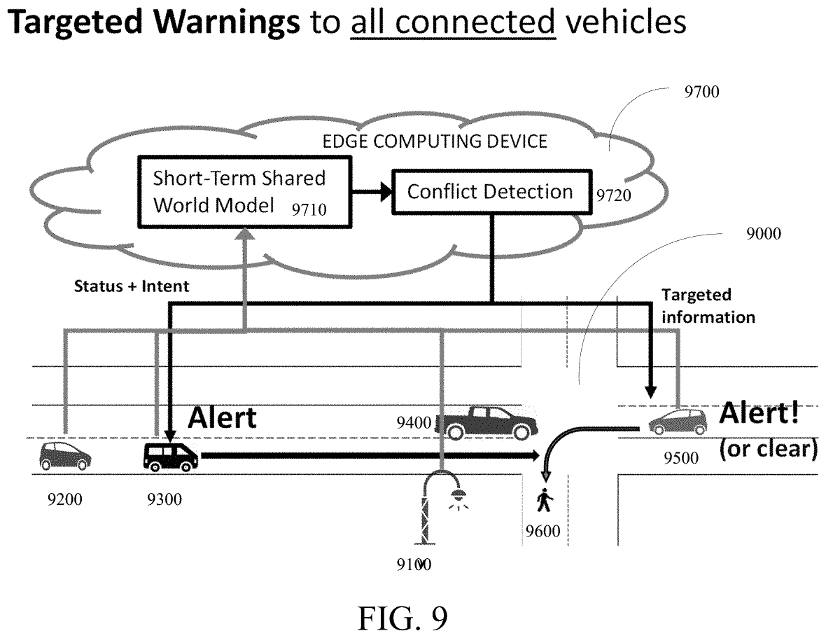

The edge compute devices such as the edge compute device 3310 and the edge compute device 3320 may provide the STSWM or real-time information to provide collision detection alerts by using transportation network data from all vehicle transportation network sources or sensors in a region and providing targeted alerts to connected vehicles. This is shown for example in FIG. 9, where an intersection 9000 may include an infrastructure sensor-roadside light 9100 and vehicles 9200, 9300, 9400, and 9500, and a pedestrian 9600. An edge computing device 9700 can obtain transportation network data the infrastructure sensor-roadside light 9100 and the vehicles 9200, 9300, 9400, and 9500, and the pedestrian 9600, when available. The edge computing device 9700 can generate the STSWM or real-time information 9710 and determine potential conflicts between the vehicles 9200, 9300, 9400, and 9500, and the pedestrian 9600 (9720). The edge computing device 9700 can generate alerts to potential collision impacted vehicles. For example, alerts can be sent to the vehicles 9300 and 9500 of a potential collision, and an alert can be sent to the vehicle 9500 of the pedestrian 9600. This can result in increased safety, increased comfort, increased energy savings, and decreased emissions.

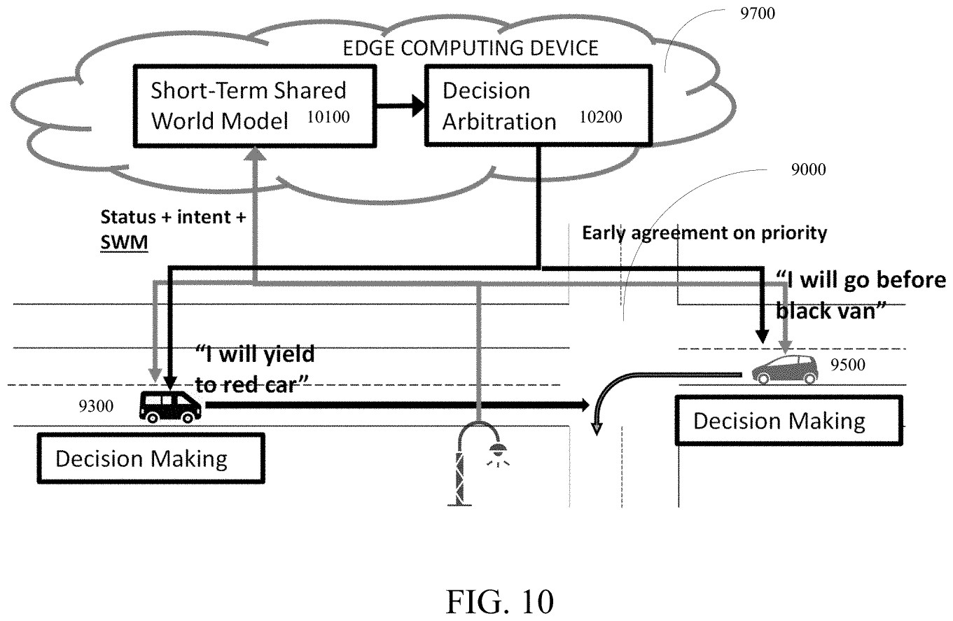

The edge compute devices such as the edge compute device 3310 and the edge compute device 3320 may provide the STSWM or real-time information to arbitrate or assist in negotiations between vehicles by using transportation network data from all vehicle transportation network sources or sensors in a region and providing targeted alerts to connected vehicles. This is shown for example in FIG. 10, which uses the intersection 9000 of FIG. 9 and the vehicles 9300 and 9500. In this instance, the edge computing device 9700 can generate the STSWM or real-time information 10100 and assist in arbitrating a decision as between the vehicles 9300 and 9500 by sending the STSWM 10100 to the vehicles 9300 and 9500, which can then use the STSWM 10100 to determine an action, such as to yield or go first.

The edge compute devices such as the edge compute device 3310 and the edge compute device 3320 may provide the STSWM or real-time information to arbitrate or assist in negotiations between vehicles by using transportation network data from all vehicle transportation network sources or sensors in a region and providing targeted alerts to connected vehicles. This is shown for example in FIG. 10, which uses the intersection 9000 of FIG. 9 and the vehicles 9300 and 9500. In this instance, the edge computing device 9700 can generate the STSWM or real-time information 10100 and assist in arbitrating a decision as between the vehicles 9300 and 9500 by sending the STSWM 10100 to the vehicles 9300 and 9500, which can then use the STSWM 10100 to determine an action, such as to yield or go first.

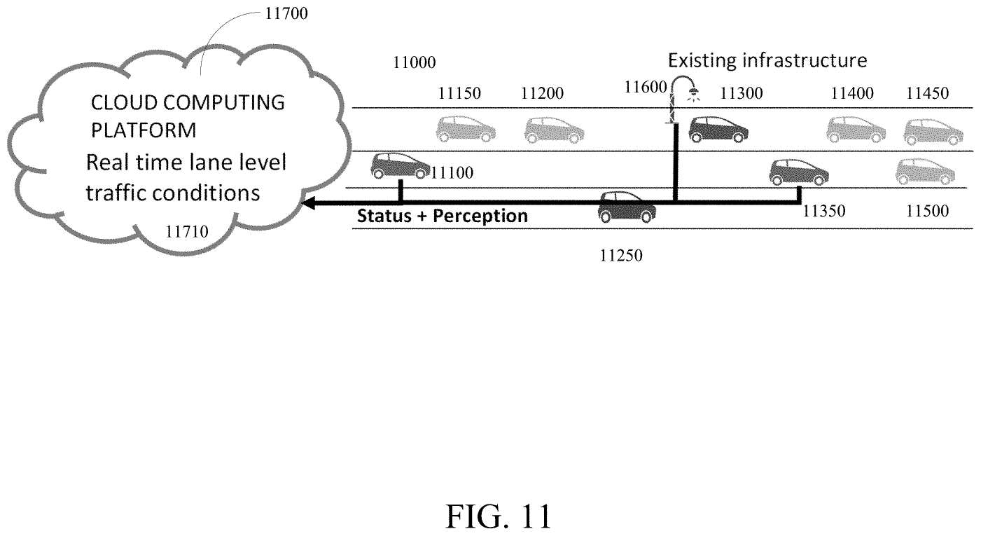

The computing platform or device 2400 may provide the LTSWM or non-real-time information to facilitate traffic or congestion management. This is illustrated in FIG. 11, where a multi-lane road 11000 may include vehicles 11100, 11150, 11200, 11250, 11300, 11350, 11400, 11450, and 11500, and an infrastructure sensor-roadside light 11600. A computing platform or device 11600 can generate the LTSWM or non-real-time information 11610 from the transportation network data collected from the vehicles 11100, 11150, 11200, 11250, 11300, 11350, 11400, 11450, and 11500, and the infrastructure sensor-roadside light 11600. The computing platform or device 11700 can provide the LTSWM or non-real-time information 11710 so that the vehicles 11100, 11150, 11200, 11250, 11300, 11350, 11400, 11450, and 11500 can determine route planning accordingly. This can result in decreased congestion, decreased energy use, and decreased emissions.

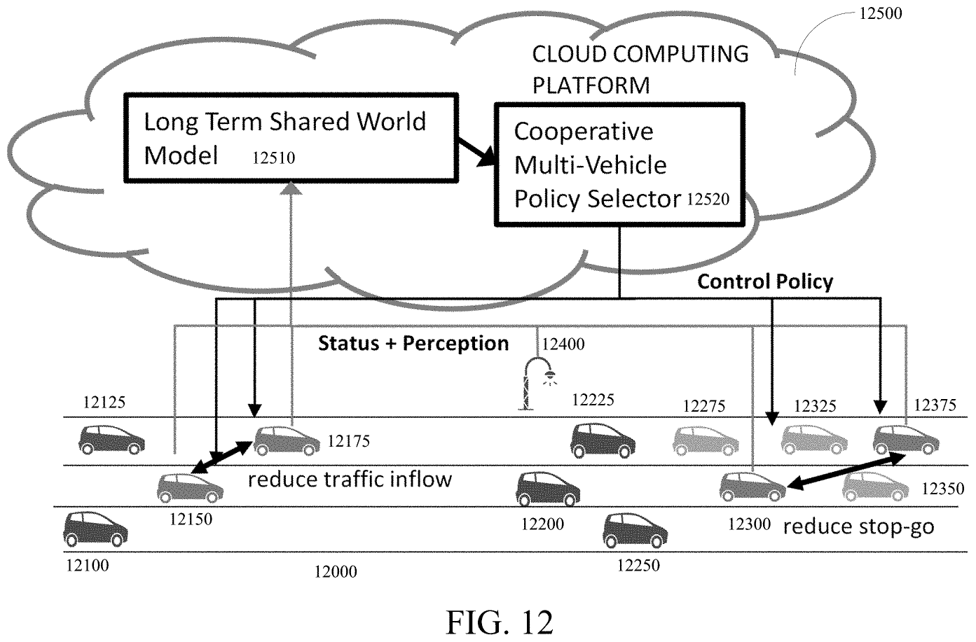

The computing platform or device 2400 may provide the LTSWM or non-real-time information to facilitate platooning or cooperative/collaborative driving. This is illustrated in FIG. 12, where a multi-lane road 12000 may include vehicles 12100, 12125, 12150, 12175, 12200, 12225, 12250, 12275, 12300, 12325, 12350, and 12375, and an infrastructure sensor-roadside light 12400. A computing platform or device 12500 can generate the LTSWM or non-real-time information 12510 from the transportation network data collected from the vehicles 12100, 12125, 12150, 12175, 12200, 12225, 12250, 12275, 12300, 12325, 12350, and 12375, and the infrastructure sensor-roadside light 12400. The computing platform or device 12500 can determine a collaborative driving policy 12520 based on the LTSWM or non-real-time information 12510. The collaborative driving policy 12520 can then be sent to target vehicles in the vehicles 12100, 12125, 12150, 12175, 12200, 12225, 12250, 12275, 12300, 12325, 12350, and 12375 to reduce traffic congestion, reduce stop-and-go driving, increase throughput, reduce breaking, increase energy efficiency, for example.

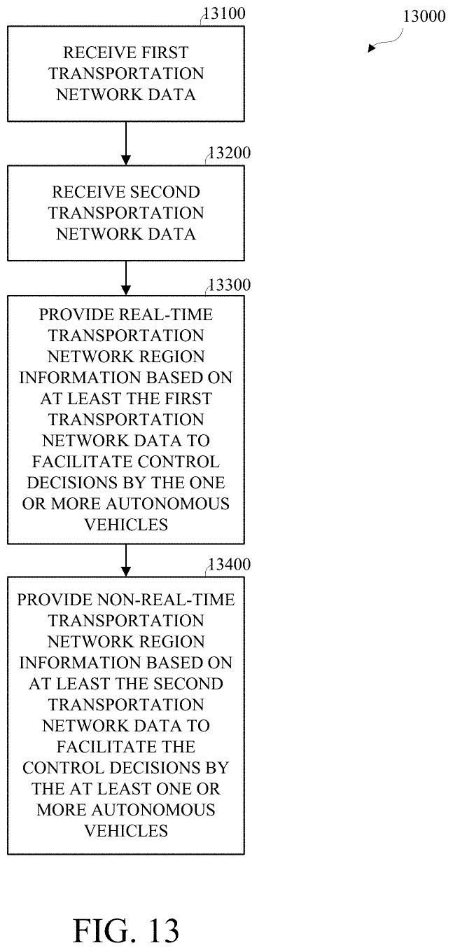

FIG. 13 is a flow diagram of an example of a method 13000 of vehicle decision making and traffic management in accordance with embodiments of this disclosure. The method 13000 includes: receiving 13100 first transportation network data; receiving 13200 second transportation network data; providing 13300 real-time transportation network region information based on at least the first transportation network data to facilitate control decisions by the one or more autonomous vehicles; and providing 13400 non-real-time transportation network region information based on at least the second transportation network data to facilitate the control decisions by the at least one or more autonomous vehicles. For example, the method 13000 may be implemented, as applicable and appropriate, by the vehicle 1000, the one or more vehicles 2100/2110, the cloud computing platform or device 2400, the edge computing device 2410, the vehicles 3510, 3520, 3530, and 3540, the compute system 3300, the edge computing device 9700, the computing platform or device 11600, and the computing platform or device 12500, as appropriate and applicable.

The method includes receiving 13100 first transportation network data. A vehicle transportation network may be represented by transportation network data obtained from infrastructure sensors, connected vehicles, and connected non-vehicles associated with a region of the vehicle transportation network (collectively first transportation network data). An edge computing device may be associated with the region to provide a local compute node. The An edge computing device may obtain the first transportation network data from the infrastructure sensors, connected vehicles, and connected non-vehicles.

The method includes receiving 13200 second transportation network data. The vehicle transportation network may be represented by first transportation network data collected from multiple regions. That is, each region has first transportation network data which can be sent to a cloud computing platform associated with the multiple regions. The cloud computing platform may obtain the first transportation network data from the edge computing device or obtain it directly from the infrastructure sensors, connected vehicles, and connected non-vehicles associated with respective regions of the vehicle transportation network. The cloud computing platform may provide a global or regional compute node in contrast to a local compute node.

The method includes providing 13300 real-time transportation network region information based on at least the first transportation network data to facilitate control decisions by the one or more autonomous vehicles. The edge computing device may compute or generate the STSWM or real-time transportation network region information from the first transportation network data, non-real time transportation network region information as provided by the cloud computing platform, or combinations thereof. The edge computing device may compute or generate the STSWM or real-time transportation network region information for use by appropriate connected vehicles or non-vehicles, use by the cloud computing platform, or combinations thereof.

The method includes providing 13400 non-real-time transportation network region information based on at least the second transportation network data to facilitate the control decisions by the at least one or more autonomous vehicles. The cloud computing platform may compute or generate the LTSWM or non-real-time transportation network region information from the second transportation network data, real time transportation network region information as provided by connected edge computing devices, or combinations thereof. The cloud computing platform may compute or generate the LTSWM or real-time transportation network region information for use by appropriate connected vehicles or non-vehicles, use by the connected edge computing devices, or combinations thereof.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method for managing vehicle and traffic conditions, comprising:
receiving, from a first set of sensors by an edge compute node, first transportation network data associated with a transportation network region;
receiving, from a second set of sensors by a cloud computing node, second transportation network data associated multiple transportation network regions;
providing, by the edge compute node to one or more autonomous vehicles at the transportation network region, real-time transportation network region information based on at least the first transportation network data to facilitate control decisions by the one or more autonomous vehicles; and
providing, by the cloud computing node to at least the one or more autonomous vehicles, non-real-time transportation network region information based on at least the second transportation network data to facilitate the control decisions by the at least one or more autonomous vehicles.

2. The method of claim 1, the method further comprising:
receiving, from one or more edge compute nodes by the cloud computing node, respective first transportation network data.

3. The method of any of claim 1, the method further comprising:
receiving, from the cloud computing node by the edge compute node, the non-real-time transportation network region information; and
determining, by the edge compute node, the real-time transportation network region information based on the non-real-time transportation network region information.

4. The method of any of claim 1, the method further comprising:
receiving, from one or more edge compute nodes by the cloud computing node, respective real-time transportation network region information; and
determining, by the cloud computing node, the non-real-time transportation network region information based on the respective real-time transportation network region information.

5. The method of any of claim 1, wherein the real-time transportation network region information includes at least occluded collision hazard information for the transportation network region.

6. The method of any of claim 1, the method further comprising:
providing the real-time transportation network region information to facilitate collaborative control decisions as between the one or more autonomous vehicles.

7. The method of any of claim 1, the method further comprising:
providing, by the edge compute node to the one or more autonomous vehicles at transportation network region, real-time collaborative control decisions to facilitate autonomous vehicle collaboration at the transportation network region.

8. The method of any of claim 1, the method further comprising:
providing the non-real-time transportation network region information to facilitate congestion management decisions by the at least one or more autonomous vehicles.

9. The method of any of claim 1, the method further comprising:
providing the non-real-time transportation network region information to the at least one or more autonomous vehicles to facilitate collaborative congestion management decisions between the at least one or more autonomous vehicles.

10. The method of any of claim 1, the method further comprising:
providing, by the cloud computing node to the at least one or more autonomous vehicles, collaborative congestion management policy decisions to facilitate autonomous vehicle collaboration by the at least one or more autonomous vehicles.

11. The method of any of claim 1, the method further comprising:
providing the non-real-time transportation network region information to facilitate energy use determinations by the one or more autonomous vehicles.

12. The method of any of claim 1, wherein the second set of sensors includes at least the first set of sensors.

13. A system, comprising:
an edge compute device configured to:
receive first transportation network data from a first set of sensors associated with a transportation network region;
provide, to one or more connected vehicles at the transportation network region, real-time transportation network region information based on at least the first transportation network data to facilitate control decisions at the one or more connected vehicles; and
a cloud computing platform connected to at least one or more edge compute devices, the cloud computing platform configured to:
receive second transportation network data from a second set of sensors; and
provide, to at least the one or more connected vehicles, non-real-time transportation network region information based on at least the second transportation network data to facilitate the control decisions at the at least one or more connected vehicles.

14. The system of claim 13, the cloud computing platform further configured to:
receive respective first transportation network data from the one or more edge compute nodes.

15. The system of claim 13, the cloud computing platform further configured to:
receive respective real-time transportation network region information from the one or more edge compute nodes, wherein the non-real-time transportation network region information is based on the respective real-time transportation network region information and the second transportation network data.

16. The system of claim 15, the edge compute device further configured to:
receive the non-real-time transportation network region information, wherein the real-time transportation network region information is based on the non-real-time transportation network region information.

17. The system of claim 13, wherein the real-time transportation network region information can facilitate one or more of notification of occluded collision hazard information and arbitrate collaborative control decisions as between the one or more autonomous vehicles.

18. The system of claim 13, wherein the non-real-time transportation network region information can facilitate congestion management decisions by the at least one or more autonomous vehicles and collaborative congestion management decisions between the at least one or more autonomous vehicles.

19. An autonomous vehicle, comprising:
a sensor system having one or more vehicle sensors;
one or more processors that execute computer-readable instructions that cause the one or more processors to:
receive, from an edge compute node, real-time transportation network region information based on at least first transportation network data associated with a transportation network region being traversed by the autonomous vehicle;
receive, from a cloud computing node, non-real-time transportation network region information based on at least second transportation network data associated with multiple transportation network regions, the transportation network region being one of the multiple transportation network regions;
determine a control action for the autonomous vehicle to perform based vehicle sensor data from the sensor system and at least one of the real-time transportation network region information and the non-real-time transportation network region information, and;
control the autonomous vehicle based on the control action.

20. The autonomous vehicle of claim 19, wherein:
the real-time transportation network region information can provide one or more of notification of occluded collision hazard information and collaborative control decision information as between other autonomous vehicles; and
the non-real-time transportation network region information can provide congestion management decisions as between other autonomous vehicles and collaborative congestion management decisions with other autonomous vehicles.
